(19) United States
(12) Patent Application Publication
(10) Pub. No.: US 2013/0316894 A1
(43) Pub. Date: Nov. 28, 2013

(54) DISTILLATE OIL HYDROGENATION DEACIDIFICATION CATALYST CONTAINING MOLECULAR SIEVE, PREPARATION AND USE THEREOF

(71) Applicants: Shoutao Ma, Beijing (CN); Zhihua Zhang, Beijing (CN); Wenzhen Xiao, Beijing (CN); Ran Tian, Beijing (CN); Famin Sun, Beijing (CN); Wencheng Zhang, Beijing (CN); Chunmei Yu, Beijing (CN); Gang Wang, Beijing (CN); Wenyong Liu, Beijing (CN); Xiufang Feng, Beijing (CN); Lihong Qin, Beijing (CN); Baoqin Dai, Beijing (CN); Fucun Wang, Beijing (CN); Dongmei Ge, Beijing (CN); Qingwu Zhang, Beijing (CN); Shuzhi Guo, Beijing (CN); Liying Liu, Beijing (CN); Jinling Zhu, Beijing (CN); Dongqing Wang, Beijing (CN)

(72) Inventors: Shoutao Ma, Beijing (CN); Zhihua Zhang, Beijing (CN); Wenzhen Xiao, Beijing (CN); Ran Tian, Beijing (CN); Famin Sun, Beijing (CN); Wencheng Zhang, Beijing (CN); Chunmei Yu, Beijing (CN); Gang Wang, Beijing (CN); Wenyong Liu, Beijing (CN); Xiufang Feng, Beijing (CN); Lihong Qin, Beijing (CN); Baoqin Dai, Beijing (CN); Fucun Wang, Beijing (CN); Dongmei Ge, Beijing (CN); Qingwu Zhang, Beijing (CN); Shuzhi Guo, Beijing (CN); Liying Liu, Beijing (CN); Jinling Zhu, Beijing (CN); Dongqing Wang, Beijing (CN)

(73) Assignee: PetroChina Company Limited, Beijing (CN)

(21) Appl. No.: 13/990,869

(22) PCT Filed: Dec. 5, 2011
(86) PCT No.: PCT/CN2011/002033

§ 371 Date: Aug. 1, 2013

(30) Foreign Application Priority Data
Dec. 3, 2010 (CN) 201010580670.7

(51) Int. Cl. B01J 29/83

(52) U.S. Cl. CPC B01J 29/83
USPC 502/66

(57) ABSTRACT

Provided are a distillate oil hydrogenation deacidification catalyst containing a molecular sieve, preparation and use thereof. In this catalyst, the weight of the catalyst, on the basis of 100%, is 1-5% magnesium calculated as an oxide, 1-20% alumino-phosphate molecular sieve and/or aluminosilicate molecular sieve; 1-10% Co and/or Ni; 5-30% Mo and/or W, and the balance is aluminium oxide. The catalyst is prepared through forming, dipping and baking. The catalyst is very active in hydrogenation deacidification, and also in hydrodesulfurization and hydrodenitrogenation.

### TECHNICAL FIELD OF THE INVENTION

The present invention relates to a distillate oil hydrodeacidification catalyst containing a molecular sieve, preparation and use thereof, particular suitable for hydrodeacidification of acid-containing heavy fraction of poor quality in petroleum refining field.

### BACKGROUND OF THE INVENTION

The acidic components in petroleum generally refer to naphthenic acid, other carboxylic acids, inorganic acid, phenol, thiol and the like, wherein naphthenic acid and other carboxylic acids are collectively known as petroleum acid, with the content of naphthenic acid in the petroleum acid being the highest. The concentration or content of acid in petroleum is represented by total acid number. Total acid number (TAN) means milligrams of potassium hydroxide (KOH) required to neutralize all the acidic components in 1 g of crude oil or petroleum fraction, and is expressed in mgKOH/g. The acid number of crude oil is an indication of the amount of the acidic components in the crude oil. Researches are shown that when the acid number in petroleum exceeds 1 mgKOH/g, acid corrosion is very severe; when the acid number of crude oil reaches 0.5 mgKOH/g, facilities corrosion is caused. During the petroleum refining, the naphthenic acid is directly reacted with iron, leading to the corrosion of heating furnace tube, heat exchanger and other oil refining facilities. The naphthenic acid can also be reacted with the protection film FeS of the petroleum facilities, causing new surfaces to be exposed by the metal facilities and new corrosion to occur. If the acidic species in the petroleum can not be removed during the refinement, it will influence the quality of the final product, causing problems of equipment failures, environment pollution and so on. As the quantity of the acid-containing crude oil exploited increases, the equipment corrosion caused by acid-containing hydrocarbon oils has drawn growing attention.

There is a large amount of naphthenic acid in the crude oil, and the acid numbers of respective cut are mostly above 2.0 mgKOH/g and up to 10.0 mgKOH/g. The naphthenic acid has to be removed in order to produce high quality product of various specifications.

Currently the methods for removing the acidic species in petroleum are primarily hydrogenation, washing with basic solution or amine alcohol solution, solvent extraction, adsorption separation and the like. Hydrodeacidification is one of the primary methods for removing the acidic components in such raw oils used worldwide. Hydrodeacidification means that the petroleum acid in the acid-containing hydrocarbon oils is reacted with hydrogen to remove carboxyl group to form hydrocarbon and water. U.S. Pat. No. 5,897,769 discloses a method of selective hydrodeacidification of acid-containing crude oil by using a small pore catalyst having a pore diameter of from 5.0 nm to 8.5 nm to selectively remove lower molecular weight naphthenic acids from an acid-containing crude oil. However, due to the presence of the small pore catalyst, there are problems of the blocking of the pore of the catalyst, short operation period and low deacidification rate resulting from the hydrogenation of only small molecular naphthenic acids. U.S. Pat. No. 5,914,030 proposes to add to the feed an expensive oil soluble or oil dispersible metal compound as a hydrogenation catalyst, but its deacidification rate is low. CN1590511A discloses a distillate oil hydrodeacidifying catalyst, comprising a hydrogenating active metal component, magnesium oxide and aluminium oxide, and after deacidification by the catalyst, the acid number of its product oil is greater than 1.0 mgKOH/g.

### SUMMARY OF THE INVENTION

The subject matter of the present invention is to provide a distillate oil hydrodeacidification catalyst having a higher deacidification activity, preparation and use thereof. The catalyst of the present invention can significantly reduce acids amount in the distillate oil under mild condition, and modestly hydrodesulfurate and hydrodenitrify while deacidifying.

The amounts of each component of the distillate oil hydrodeacidification catalyst of the present invention are: 1-5% of magnesium based on the amount of the oxides; 1-20% of P—Al molecular sieve and/or Si—Al molecular sieve; 1-10% of Co and/or Ni; 5-30% of Mo and/or W, relative to 100% of the weight of the catalyst; the remainder is alumina.

The method for preparing the catalyst provided by the present invention comprises mixing uniformly the molecular sieve powder and alumina in proportion, extrude molding, baking followed by impregnating with solution of magnesium-containing compounds, drying and baking to obtain a catalyst carrier, and then introducing the hydrogenation active metal components containing aid an auxiliary agent phosphorus. The method further comprises mixing alumina, molecular sieve powder and magnesium oxide and/or magnesium-containing compound, molding and baking to obtain the catalyst carrier, and then introducing the hydrogenation active metal components containing aid phosphorus.

### DETAILED DESCRIPTION OF THE EMBODIMENTIES

The Si—Al molecular sieve ZSM-5 used in the distillate oil hydrodeacidification catalyst of the present invention has the properties as follows: SiO₂/Al₂O₃ molar ratio of 25-38, preferably 30-35; Na₂O<0.1%; and the pore volume is not less than 0.17 ml/g.

The P—Al molecular sieve AlPO₄-5 used in the distillate oil hydrodeacidification catalyst of the present invention has the properties as follows: P₂O₅/Al₂O₃ molar ratio of 1.0-5.0, preferably 1.5-4.5; Na₂O<0.2%, most preferably less than 0.15%.

The alumina used in the present invention is commercial available pseudoboehmite, or commercial available alumina carrier having an appropriate pore distribution.

Preferably, the alumina is an alumina in which the pore volume of the pores with a pore diameter above 10 nm is above 70% of the total pore volume.

According to the method of the present invention, introducing the hydrogenation active metal components into a mixture of magnesium oxide, alumina and molecular sieve powder is carried out by contacting the mixture of magnesium oxide, alumina and molecular sieve powder with a solution containing phosphorus compound, nickel and/or cobalt metal compounds, molybdenum and/or tungsten metal compound, for example, by impregnation, under a condition sufficient to deposit the aids phosphorus and nickel and/or cobalt, molybdenum and/or tungsten active components onto the mixture.

The mixture of magnesium oxide, alumina and molecular sieve powder may be produced by molding a mixture of pseudoboehmite and molecular sieve powder, baking and impregnating the mixture with a solution of magnesium-containing compound, and then drying and baking, or produced by mixing pseudoboehmite, molecular sieve and magnesium oxide and/or magnesium-containing compound, molding and baking.

According to the method provided by the present invention, the processes for formulating an impregnating solution and impregnation are conventional processes. It is well known for the person skilled in the art to prepare catalyst with specified metal contents by adjusting and controlling the concentration of the impregnating solution, the amount of the impregnating solution or the amount of the carrier.

The magnesium-containing compound is preferably one or more of magnesium oxide or inorganic acid salts containing magnesium and organic acid salts containing magnesium, for example, one or more of magnesium nitrate, magnesium sulfate and magnesium stearate.

The molybdenum-containing compound is selected from soluble compounds containing molybdenum, for example, one or more of ammonium molybdate, ammonium paramolybdate and ammonium phosphomolybdate.

The nickel-containing compound is selected from soluble compounds containing nickel, for example, one or more of nickel nitrate, basic nickel carbonate and nickel chloride.

The tungsten-containing compound is selected from soluble compounds containing tungsten, for example, one or more of ammonium metatungstate, and ethyl ammonium metatungstate.

The cobalt-containing compound is selected from soluble compounds containing cobalt, for example, one or more of cobalt acetate, and cobalt carbonate.

The phosphorus compound is preferably water soluble compound containing phosphorus, for example, one or more of phosphoric acid, ammonium phosphate, and ammonium biphosphate.

According to the conventional methods in the art, prior to the use of the catalyst provided in the present invention, pre-vulcanization may be carried out by using sulfur, hydrogen sulfide or sulfur-containing raw materials at a temperature of 140-370° C. in the presence of hydrogen. Such pre-vulcanization can be performed outside of the reactor, or occurs in situ within the reactor for conversion into sulfide form.

The reagents used in examples are all industrial grade reagents, unless stated otherwise.

The pore distribution is measured by BET low temperature nitrogen adsorption, and the amounts of molybdenum, nickel, magnesium and phosphorus are measured by using X-ray fluorescence.

Examples 1-4 are used to illustrate the mixture of magnesium oxide, alumina and molecular sieve powder suitable for the present invention and the preparation thereof.

### EXAMPLE 1

Alumina formed by baking 150 g pseudoboehmite at 460° C. for 4 hours, 20 g P—Al molecular sieve AlPO₄-5, 25 g Si—Al molecular sieve ZSM-5 are added and mixed with 160 ml aqueous solution containing 70.4 g magnesium nitrate (product from Taiyuan Xinli Chemicals Co., LTD), and extruded into a 1.5 mm strip in a shamrock shape. The strip is dried at 120° C. and baked at 580° C. in air for 4 hours, to yield carrier MAZ-1. The pore distribution and the amount of the magnesium oxide of the carrier MAZ-1 are listed in Table 1.

### EXAMPLE 2

150 g pseudoboehmite, 20 g P—Al molecular sieve AlPO₄-5, 25 g Si—Al molecular sieve ZSM-5 are mixed uniformly, and extruded into a 1.5 mm strip in a shamrock shape. The strip is dried at 120° C. and baked at 550° C. for 4 hours. After cooling, the strip is impregnated with 500 ml aqueous solution containing 87.3 g magnesium nitrate. The wet strip is dried at 120° C., and baked at 580° C. in air for 4 hours, to yield carrier MAZ-2. The pore distribution and the amount of the magnesium oxide of the carrier MAZ-2 are listed in Table 1.

### EXAMPLE 3

150 g pseudoboehmite and 20 g P—Al molecular sieve AlPO₄-5 are mixed uniformly, and extruded into a 1.5 mm strip in a shamrock shape. The strip is dried at 120° C. and baked at 550° C. for 4 hours. After cooling, the strip is impregnated with 500 ml aqueous solution containing 47.3 g magnesium stearate. The wet strip is dried at 120° C., and baked at 580° C. in air for 4 hours, to yield carrier MAZ-3. The pore distribution and the amount of the magnesium oxide of the carrier MAZ-3 are listed in Table 1.

### EXAMPLE 4

150 g pseudoboehmite and 25 g Si—Al molecular sieve ZSM-5 are mixed uniformly, and extruded into a 1.5 mm strip in a shamrock shape. The strip is dried at 120° C. and baked at 550° C. for 4 hours. After cooling, the strip is impregnated with 500 ml aqueous solution containing 82.7 g magnesium nitrate. The wet strip is dried at 120° C., and baked at 580° C. in air for 4 hours, to yield carrier MAZ-4. The pore distribution and the amount of the magnesium oxide of the carrier MAZ-4 are listed in Table 1.

### EXAMPLE 5

150 g pseudoboehmite, 25 g P—Al molecular sieve AlPO₄-5, 20 g Si—Al molecular sieve ZSM-5 are mixed uniformly, and extruded into a 1.5 mm strip in a shamrock shape. The strip is dried at 120° C. and baked at 550° C. for 4 hours. After cooling, the strip is impregnated with 500 ml aqueous solution containing 87.3 g magnesium nitrate. The wet strip is dried at 120° C., and baked at 580° C. in air for 4 hours, to yield carrier MAZ-5. The pore distribution and the amount of the magnesium oxide of the carrier MAZ-5 are listed in Table 1.

### EXAMPLE 6

150 g pseudoboehmite, 20 g P—Al molecular sieve AlPO₄-5, 20 g Si—Al molecular sieve ZSM-5 are mixed uniformly, and extruded into a 1.5 mm strip in a shamrock shape. The strip is dried at 120° C. and baked at 550° C. for 4 hours. After cooling, the strip is impregnated with 500 ml aqueous solution containing 86.6 g magnesium nitrate. The wet strip is dried at 120° C., and baked at 580° C. in air for 4 hours, to yield carrier MAZ-6. The pore distribution and the amount of the magnesium oxide of the carrier MAZ-6 are listed in Table 1.

### COMPARATIVE EXAMPLE 1

150 g pseudoboehmite (the same as that in example 1) is extruded into a 1.5 mm strip in a shamrock shape. The strip is dried at 120° C. and baked at 550° C. for 4 hours. After cooling, the strip is impregnated with 500 ml aqueous solution containing 78.3 g magnesium nitrate. The wet strip is dried at 120° C., and baked at 580° C. in air for 4 hours, to yield carrier MA-1. The pore distribution and the amount of the magnesium oxide of the carrier MA-1 are listed in Table 1.

### COMPARATIVE EXAMPLE 2

150 g pseudoboehmite is extruded into a 1.5 mm strip in a shamrock shape. The strip is dried at 120° C. and baked at 550° C. for 4 hours. After cooling, the strip is impregnated with 500 ml aqueous solution containing 78.3 g magnesium nitrate. The wet strip is dried at 120° C., and baked at 580° C. in air for 4 hours, to yield carrier MA-2. The pore distribution and the amount of the magnesium oxide of the carrier MA-2 are listed in Table 1.

### COMPARATIVE EXAMPLE 3

150 g pseudoboehmite (the same as that in example 1), 20 g P—Al molecular sieve AlPO₄-5, 20 g Si—Al molecular sieve ZSM-5 are mixed uniformly and extruded into a 1.5 mm strip in a shamrock shape. The strip is dried at 120° C. and baked at 550° C. for 4 hours, to yield carrier AZ-3. The pore distribution and the amount of the magnesium oxide of the carrier AZ-3 are listed in Table 1.

TABLE 1
Properties of the carriers

| | | Proportion of the pores with |
|---|---|---|
| Example | MgO, % | pore diameters above 10 nm, % |
| 1 | 5.0 | 11.9 |
| 2 | 4.8 | 12.1 |
| 3 | 4.7 | 13.0 |
| 4 | 5.3 | 12.6 |
| 5 | 5.1 | 11.4 |
| 6 | 5.0 | 11.6 |
| Comparative | 5.0 | 60 |
| example 1 | | |
| Comparative | 5.0 | 25.3 |
| example 2 | | 12.7 |
| Comparative | — | |
| example 3 | | |

### EXAMPLE 7

The example is used to illustrate the hydrodeacidification catalyst provided by the present invention and the preparation thereof.

The impregnating solution is formulated via conventional methods. Specifically, 20.5 g phosphoric acid having a concentration of 85% is diluted with deionized water into a solution. The solution is mixed with 44.8 g ammonium molybdate and 40.3 g nickel nitrate. The mixture is heated under stirring until completely dissolve, to yield impregnating solution.

MAZ-1 carrier is weighed, impregnated with the formulated impregnating solution, dried at 120° C. for 4 hours and baked at 550° C. for 4 hours, to yield catalyst C1, the composition of which is present in Table 2.

Carriers MAZ-2, MAZ-3, MAZ-4, MAZ-5 and MAZ-6 are weighted successively to produce catalysts C2, C3, C4, C5 and C6, respectively. The compositions of the catalysts are present in Table 2.

### COMPARATIVE EXAMPLE 4

This comparative example is used to illustrate the control catalyst and the preparation thereof.

Carriers MA-1, MA-2 and AZ-3 are weighed successively to produce catalysts D1, D2 and D3, respectively, under the same condition as in example 7. The compositions of the catalysts are present in Table 2.

TABLE 2
Compositions of the catalysts

| | Example | | | | | | | | |
|---|---|---|---|---|---|---|---|---|---|
| | Example 7 | | | | | | Comparative Example 4 | | |
| Catalyst | C1 | C2 | C3 | C4 | C5 | C6 | D1 | D2 | D3 |
| Carrier | MAZ-1 | MAZ-2 | MAZ-3 | MAZ-4 | MAZ-5 | MAZ-6 | MA-1 | MA-2 | AZ-3 |
| MoO₃, | 23.6 | 23.5 | 23.7 | 24.0 | 23.4 | 23.5 | 23.5 | 23.5 | 23.5 |
| wt. % | | | | | | | | | |
| NiO, | 4.9 | 4.8 | 5.7 | 4.7 | 5.1 | 5.0 | 5.0 | 5.0 | 5.0 |
| wt. % | | | | | | | | | |
| P₂O₅, | 2.7 | 2.5 | 2.33 | 2.43 | 2.6 | 2.5 | 2.5 | 2.5 | 2.5 |
| wt. % | | | | | | | | | |
| MgO, | 2.50 | 2.43 | 2.40 | 2.60 | 2.54 | 2.51 | 2.51 | 2.51 | — |
| wt. % | | | | | | | | | |

### EXAMPLE 8

This example is used to illustrate the hydrodeacidification property of the catalyst of the present invention.

The reaction is carried out on continuous flowing microreactor chromatography. The raw oil is a 10% n-hexane solution of cyclohexylformic acid, and the charge of the catalyst is 0.3 g.

Prior to feeding, the catalysts C1, C2, C3, C4, C5 and C6 are pre-vulcanized with vulcanizing oil which is a mixed solution of 3 wt % of carbon disulfide and cyclohexane. The vulcanization conditions are as follows: pressure of 4.1 MPa, temperature of 300° C., time of 2.5 hours, the feeding rate of the vulcanizing oil of 0.2 ml/minutes, and the flow rate of the hydrogen gas of 400 ml/minutes. Then the raw oil is introduced to react under the reaction condition being as follows: pressure of 4.1 MPa, the feeding rate of the raw oil of 0.1 ml/min, volume ratio of hydrogen to oil of 4000:1, temperature of 300° C. After reacting for 3 hours, sample is taken to perform chromatography analysis on line. The chromatography column is a 3 m packed column (101 supporter, OV-17 stationary phase). Thermal conductivity detector is used. The conversion of the cyclohexylformic acid is calculated according to the following equation:

the conversion of the cyclohexylformic acid=[(the amount of the cyclohexylformic acid in raw oil−the amount of the cyclohexylformic acid in product)/the amount of the cyclohexylformic acid in raw oil]×100%

The results are present in Table 3.

### COMPARATIVE EXAMPLE 5

This example is used to illustrate the hydrodeacidification property of the comparative catalyst.

Comparative catalysts D1, D2 and D3 are evaluated by the same method as example 8. The results are present in Table 3.

TABLE 3
Conversion of cyclohexylformic acid

| | Conversion of |
|---|---|
| Catalyst No. | cyclohexylformic acid (%) |
| C1 | 54.9 |
| C2 | 55.1 |
| C3 | 53.7 |
| C4 | 53.2 |
| C5 | 54.7 |
| C6 | 56.3 |
| D1 | 30.1 |
| D2 | 25.4 |
| D3 | 11.2 |

From Table 3, it can be seen that the hydrogenation conversion activities of cyclohexylformic acid of the catalysts of the present invention is significantly higher than those of the catalysts of the comparative examples. The hydrogenation activities of catalysts C1, C2, C5 and C6 incorporating two molecular sieves are higher than those of catalysts C3 and C4. Meanwhile, it is found that when the amounts of the active metal components are close, the hydrogenation activity of the catalyst incorporating two molecular sieves in respective amount of 10 wt % is clearly higher than those of other catalysts incorporating molecular sieve. Compared with the catalyst having free of magnesium, the hydrogenation activity of the catalyst incorporating aid magnesium is considerably improved. From comparative catalysts D1 and D2, it can be seen that the hydrogenation activity of the catalysts having relatively larger carrier pore diameter is clearly higher.

### EXAMPLE 9

This example is used to illustrate the distillate oil hydrodeacidification property of the catalyst of the present invention.

The raw oil used is the vacuum cut II from Liaohe with the acid number of 6.30 mgKOH/g, the properties of which are present in Table 4.

Catalyst C6 is crushed into particles having a diameter of 2 mm-3 mm. 120 ml of the catalyst is charged into a 200 ml fixed bed reactor. Prior to feeding, the catalyst is vulcanized with kerosene containing 2 wt % carbon disulfide. Then the raw materials are introduced to react. The vulcanization condition and the reaction condition are present in Table 5. The results are present in Table 6.

TABLE 4
Properties of the raw oil

| | Vacuum cut II |
|---|---|
| Density, Kg/m³ | 0.9586 |
| Acid number, mgKOH/g | 6.30 |
| Colorimetry, number | >8 |
| Sulfur content, μg/g | 1361.6 |
| Nitrogen content, μg/g | 774.0 |
| Condensation point, ° C. | 7.6 |

TABLE 5
200 ml vulcanization condition and reaction condition

| | Reaction | Partial | Volume | Volume ratio |
|---|---|---|---|---|
| | tempera- | pressure of | airspeed, | of hydrogen |
| | ture, ° C. | hydrogen, MPa | h⁻¹ | and oil |
| Vulcanization | 300 | 3.2 | 2 | 200:1 |
| condition | | | | |
| Reaction | 320 | 4.2 | 1 | 400:1 |
| condition | | | | |

COMPARATIVE EXAMPLE 6

This example is used to illustrate the distillate oil hydrodeacidification of the comparative catalyst.

Comparative catalysts D1, D2 and D3 are evaluated by the same method as example 9. The reaction results are present in Table 6.

TABLE 6
Evaluation results of comparing the hydrogenation of the catalysts

| | | |
|---|---|---|
| Item | Example 7 | Comparative example 4 |

| | | | | |
|---|---|---|---|---|
| Catalyst | C6 | D1 | D2 | D3 |
| Acid number of | 0.05 | 0.92 | 0.17 | 0.27 |
| product, mgKOH/g | | | | |
| Nitrogen content of | 7 | 25 | 21 | 20 |
| product, μg/g | | | | |
| Sulphur content of | 12 | 44 | 31 | 56 |
| product, μg/g | | | | |

The acid number of the distillate oil and the product thereof is determined according to GB/T 264-91, the nitrogen content is determined according to ASTM D4629, and the sulphur content is determined according to ASTM D5453.

From Table 6, it can be seen that the hydrodeacification catalyst C6 incorporating molecular sieve has good hydrodeacification ability, and good hydrogenation effect for poor-quality distillate oil comprising large amount of sulphur and nitrogen, thereby avoiding the addition of refining reactor, and thus is an efficient distillate oil hydrodeacidification catalyst.

### INDUSTRIAL APPLICABILITY

P—Al molecular sieve AlPO₄-5 and/or Si—Al molecular sieve ZSM-5 are used in the catalyst of the present invention. Due to the selectivity of the molecular sieves, the hydroacidification property of the catalyst is improved, thereby enabling the catalyst to process the heavy fraction of poor-quality distillate oil under mild processing condition and have good deacidification selectivity.

Compared with the existing catalysts, the catalyst of the present invention shows significantly improved hydroacidification activity, and has a certain hydrodesulfuration and hydrodenitrification properties.

1. A distillate oil hydrodeacidification catalyst comprising:
1-5% of magnesium based on the amount of magnesium oxides;
at least one of 1-20% of P—Al molecular sieve, or 1-20% of Si—Al molecular sieve;
at least one of 1-10% of Co, or 1-10% of Ni;
at least one of 5-30% of Mo, or 5-30% of W, relative to 100% of the weight of the catalyst; and
alumina.

2. The catalyst according to claim 1, comprising the P—Al molecular sieve, wherein the P—Al molecular sieve is selected from the group consisting of AlPO₄-5, and SAPO-11.

3. The catalyst according to claim 1, comprising the Si—Al molecular sieve, wherein the Si—Al molecular sieve is selected from the group consisting of ZSM-5, ZSM-22, and ZSM-23.

4. The catalyst according to claim 1, wherein the alumina is an alumina in which the pore volume of the pores with a pore diameter above 10 nm is above 70% of the total pore volume.

5. The catalyst according to claim 1, wherein the alumina is pseudoboehmite.

6. A method for preparing a distillate oil hydrodeacidification catalyst comprising:
mixing alumina and a molecular sieve to provide a mixture;
impregnating the mixture in a solution of magnesium containing compound to provide a catalyst carrier; and
introducing a hydrogenation-active metal component to the catalyst carrier to provide the distillate oil hydrodeacidification catalyst.

7. The method wherein the magnesium containing compound is selected from the group consisting of inorganic salts of magnesium, organic acid salts of magnesium, and combinations thereof.

8. A method for treating a distillate oil, comprising applying a catalyst after vulcanization of the distillate oil, wherein the catalyst comprises:
1-5% of magnesium based on the amount of the oxides;
at least one of 1-20% of P—Al molecular sieve, or 1-20% of Si—Al molecular sieve;
at least one of 1-10% of Co, or 1-10% of Ni;
at least one of 5-30% of Mo or 5-30% of W, relative to 100% of the weight of the catalyst; and
alumina.

9. The catalyst according to claim 1 comprising AlPO₄-5 molecular sieves and ZSM-5 molecular sieves.

10. The catalyst according to claim 1, comprising ZSM-5 molecular sieve, wherein the ZSM-5 molecular sieve has a molar ratio of SiO₂/Al₂O₃ at 25-38, the weight percentage of Na₂O in the catalyst is smaller than 0.1%, and the pore volume of the catalyst is not less than 0.17 mL/g.

11. The catalyst according to claim 1, comprising AlPO₄-5 molecular sieve, wherein the AlPO₄-5 molecular sieve has a molar ratio of P₂O₅/Al₂O₃ at 1.0-5.0, and the weight percentage of Na₂O in the catalyst is smaller than 0.2%.

12. The method according to claim 6, wherein the magnesium containing compound is selected from the group consisting of magnesium nitrate, magnesium sulfate, magnesium stearate, and combinations thereof.

13. The method according to claim 6, wherein introducing a hydrogenation-active metal component is carried out in a solution containing a phosphorus compound, at least one of nickel and cobalt compounds, and at least one of molybdenum and tungsten compounds.

14. The method according to claim 13, wherein the phosphorus compound is selected from the group consisting of phosphoric acid, ammonium phosphate, ammonium biphosphate, and combinations thereof.

15. The method according to claim 13, wherein the solution comprises the molybdenum compound, and wherein the molybdenum compound is selected from the group consisting of ammonium molybdate, ammonium paramolybdate, ammonium phosphomolybdate, and combinations thereof.

16. The method according to claim 13, wherein the solution comprises the nickel compound, and wherein the nickel compound is selected from the group consisting of nickel nitrate, nickel carbonate, nickel chloride, and combinations thereof.

17. The method according to claim 13, wherein the solution comprises the tungsten compound, and wherein the tungsten compound is selected from the group consisting of ammonium metatungstate, ethyl ammonium metatungstate, and combinations thereof.

18. The method according to claim 6, wherein the solution comprises the cobalt compound, and wherein the cobalt compound is selected from the group consisting of cobalt acetate, cobalt carbonate, and combinations thereof.

19. The method according to claim 6, further comprising a step of baking the catalyst carrier, wherein the baking temperature is between 400° C.-600° C. and the baking time is 3 hours to 6 hours.

20. The method according to claim 8, wherein the treating comprises hydrodeacidification, hydrodesulfuration and hydrodenitrification.
